(19) United States
(12) Patent Application Publication
(10) Pub. No.: US 2013/0052481 A1
(43) Pub. Date: Feb. 28, 2013

(54) HARD FACE STRUCTURE AND BODY COMPRISING SAME

(71) Applicants: Igor Yuri Konyashin, Huenfeld (DE); Bernd Heinrich Ries, Huenfeld (DE); Frank Friedrich Lachmann, Burghaun (DE)

(72) Inventors: Igor Yuri Konyashin, Huenfeld (DE); Bernd Heinrich Ries, Huenfeld (DE); Frank Friedrich Lachmann, Burghaun (DE)

(73) Assignee: ELEMENT SIX GMBH, Burghaun (DE)

(21) Appl. No.: 13/641,144

(22) PCT Filed: Apr. 7, 2011
(86) PCT No.: PCT/EP2011/055453

§ 371 Date: Nov. 15, 2012

(30) Foreign Application Priority Data
Apr. 16, 2010 (GB) 1006365.9

(51) Int. Cl. E21C 35/183; B23K 31/00; B32B 15/01

(52) U.S. Cl. 428/679; 428/683; 299/105; 228/195; 228/164

(57) ABSTRACT

A body comprising a steel substrate and a hard face structure fused to the steel substrate, the hard face structure comprising a core region and an intermediate region, the intermediate region at least partially enclosing the core region and comprising at least about 0.5 weight % Si, at least about 3 weight % Cr and at least about 10 weight % W and substantially the balance of the intermediate region consisting of an iron group metal M and carbon, M being selected from Fe, Co and Ni or an alloy thereof, and the intermediate region including a plurality of crystallites comprising at least one eta-phase or theta-phase according to the formula MₓW_{y}C_{z}, where x is in the range from 1 to 7, y is in the range from 1 to 10 and z is in the range from 1 to 4, or a mixture of an eta-phase and a theta-phase according to the formula; the core region comprising at least about 1 weight % Si, at least about 5 weight % Cr, at least about 40 weight % W and substantially the balance of the core region consisting of M and carbon, the core region including grains comprising WC and grains comprising (M,Cr),C₃ or grains comprising (M,Cr)₂₃C₆, or grains comprising (M,Cr)₇C₃ and grains comprising (M,Cr)₂₃C₆, the grains being dispersed in core region matrix material comprising more than 50 weight % of the M containing Cr, W and Si in solid solution therein; the intermediate region being substantially free of WC grains.

The invention relates generally to a hard face structure for a steel body and to a steel body comprising the hard face structure. More particularly, but not exclusively, the invention relates to a hard face structure for a pick tool for pavement or rock degradation.

Pick tools may be used for breaking, degrading or boring into bodies, such as rock, asphalt, coal or concrete, for example, and may be used in applications such as mining, construction and road reconditioning. In some applications, for example road reconditioning, a plurality of pick tools may be mounted on a rotatable drum and driven against the body to be degraded as the drum is rotated against the body.

Pick tools may comprise a working tip of a superhard material, for example polycrystalline diamond (PCD), which comprises a mass of substantially inter-grown diamond grains forming a skeletal mass defining interstices between the diamond grains. PCD material typically comprises at least about 80 volume % of diamond and may be made by subjecting an aggregated mass of diamond grains to an ultra-high pressure of greater than about 5 GPa, for example, and a temperature of at least about 1,200° C., for example.

U.S. Pat. No. 3,725,016 discloses a titanium carbide hard-facing steel-base composition consisting essentially of about 10 to 75 weight % TiC with a steel-forming matrix making up essentially the balance.

PCT patent application publication number WO/2010/029518 discloses a hard-metal comprising at least 13 volume % of a metal carbide selected from TiC, VC, ZrC, NbC, MoC, HfC, TaC, WC or a combination thereof and a binder phase comprising one or more of an iron-group metal or an alloy thereof and 0.1 to 10 weight % Si and 0.1 to 10 weight % Cr and having a liquidus temperature at 1280 degrees centigrade or lower and 3 to 39 volume % of diamond or CBN coated with a protective coating or a mixture thereof.

PCT patent application publication number WO/2010/029522 discloses a wear part or tool comprising: a body containing an iron-group metal or alloy, a wear-resistant layer metallurgically bonded to a surface of the body through an intermediate layer.

German patent number 3 618 198 discloses a method of hard-facing a steel chisel tool by placing a powder comprising carbide and metal particles between the head of the tool and a mold and arc welding the particle mixture to the tool head.

There is a need to provide wear parts comprising steel that exhibit enhanced wear behaviour and a cost-effective method of making them.

### SUMMARY

Viewed from a first aspect there can be provided a body comprising a steel substrate and a hard face structure fused to the steel substrate, the hard face structure comprising a core region and an intermediate region, the intermediate region at least partially enclosing the core region and comprising at least about 0.5 weight % Si, at least about 3 weight % Cr and at least about 10 weight % W and substantially the balance of the intermediate region consisting of an iron group metal M and carbon, M being selected from Fe, Co and Ni or an alloy thereof, and the intermediate region including a plurality of crystallites comprising at least one eta-phase or theta-phase according to the formula MₓW_{y}C_{z}, where x is in the range from 1 to 7, y is in the range from 1 to 10 and z is in the range from 1 to 4, or a mixture of an eta-phase and a theta-phase according to the formula; the core region comprising at least about 1 weight % Si, at least about 5 weight % Cr, at least about 40 weight % W and substantially the balance of the core region consisting of M and carbon, the core region including grains comprising WC and grains comprising (M,Cr),C₃ or grains comprising (M,Cr)₂₃C₆, or grains comprising (M,Cr),C₃ and grains comprising (M,Cr)₂₃C₆, the grains being dispersed in core region matrix material comprising more than 50 weight % of the M containing Cr, W and Si in solid solution therein; the intermediate region being substantially free of WC grains.

Viewed from a second aspect there can be provided a method for making a body comprising a steel substrate and a hard face structure fused to the steel substrate, the method including contacting a precursor body with a steel substrate, the precursor body comprising at least 13 volume % WC grains, Si in the range from 0.1 weight % to 10 weight %, and Cr in the range from 0.1 weight % to 10 weight %, the rest is M, and having a liquidus temperature of at most about 1,280 degrees centigrade; heating the precursor body to a temperature of at least the liquidus temperature for a time period controlled to allow a peripheral region of the precursor body to react and fuse with the steel and to avoid complete reaction of a core region of the precursor body with the steel.

### BRIEF INTRODUCTION TO THE DRAWINGS

Non-limiting example arrangements to illustrate the present disclosure are described hereafter with reference to the accompanying drawings, of which:

FIG. 1 shows a schematic perspective view of an example pick tool for pavement degradation.

FIG. 2 shows a schematic partial cut-away side view of an example pick tool with a hard face structure fused to a portion of a steel body.

FIG. 3 shows a schematic partial cross section of an expanded portion of the example pick tool shown in FIG. 1.

FIG. 4 shows a schematic image of the microstructure of the intermediate material of an example hard face structure.

FIG. 5 shows a schematic perspective view of an example of a pick tool with a pair of precursor rings for producing a hard face structure fused onto the pick tool.

FIG. 6 shows a schematic cross section view of a portion of an example hard face structure fused to a steel substrate.

The same references are used to refer to the same features in all drawings.

### DETAILED DESCRIPTION

Certain terms as used herein will be explained.

As used herein, a hard face structure is a structure such as, but not limited to, a layer joined to a substrate to protect the substrate from wear. The hard face structure exhibits a substantially greater wear resistance than does the substrate.

As used herein, the word “tool” is understood to mean “tool or component for a tool”.

As used herein, a wear part is a part or component that is subjected, or intended to be subjected to wearing stress in application. There are various kinds of wearing stress to which wear parts may typically be subjected such as abrasion, erosion, corrosion and other forms of chemical wear. Wear parts may comprise any of a wide variety of materials, depending on the nature and intensity of wear that the wear part is expected to endure and constraints of cost, size and mass. For example, cemented tungsten carbide is highly resistant to abrasion but due to its high density and cost is typically used only as the primary constituent of relatively small parts, such as drill bit inserts, chisels, cutting tips and the like. Larger wear parts may be used in excavation, drill bit bodies, hoppers and carriers of abrasive materials and are typically made of hard steels which are much more economical than cemented carbides in certain applications.

As used herein, a hardmetal is a material comprising grains of metal carbide such as WC dispersed within a metal binder, particularly a binder comprising cobalt. The content of the metal carbide grains is at least about 50 weight % of the material.

Example arrangements of hard face structures and bodies comprising hard face structures will be described.

In one example arrangement, x is in the range from about 2 to about 4 and y is in the range from about 2 to about 4. In one embodiment, x is 3 and y is 3.

In one example arrangement, the grains of the eta-phase or the theta-phase, or both, comprise at least about 1 weight % Cr and at least about 1 weight % Si, the eta-phase phase or theta phase, or both, being dispersed in an intermediate region matrix material comprising at least about 1 weight % Si and at least about 2 weight % Cr.

In one example arrangement, the grains comprising (M,Cr),C₃ or the grains comprising (M,Cr)₂₃C₆, or both, comprise at least about 1 weight % Si and the core matrix material comprises at least about 1 weight % Si, at least about 5 weight % W and at least about 5 weight % Cr.

In one example arrangement, the intermediate region has a thickness of at least about 0.5 mm or at least about 1 mm, the thickness being the shortest distance between a point lying on the boundary with the core region and the closest point lying on the boundary with the steel substrate.

In one example arrangement, the core region and the intermediate region of the hard face structure have Vickers hardness of at least about 700 HV10 or at least about 800 HV10. In some embodiments, the core region and the intermediate region of the hard face structure have Vickers hardness of at least about 700 HV10 or at least about 750 HV10. In some embodiments, the core region and the intermediate region of the hard face structure have Vickers hardness of at most about 900 HV10 or at most about 850 HV10.

In one example arrangement, the core region and the intermediate region of the hard face structure have a Palmquist fracture toughness of at least about 20 MPa.m^{1/2}.

In one example arrangement, the hard face structure comprises a plurality of core regions embedded within the intermediate region, and in some embodiments the hard face region comprises two or three core regions. In one embodiment, at least one core region has a generally annular form.

In some example arrangements, the body is a tool or a wear part for use in high wear applications. In one embodiment of the invention, the body is a tool or a wear part for use in pavement or rock degradation. In one embodiment, the tool comprises a tip formed of polycrystalline diamond. In one embodiment, the body is a pick tool for pavement degradation, comprising a steel substrate having a longitudinal axis and having a generally cylindrical, conical or frustoconical portion and a generally annular or other co-axial hard face structure fused to the steel substrate.

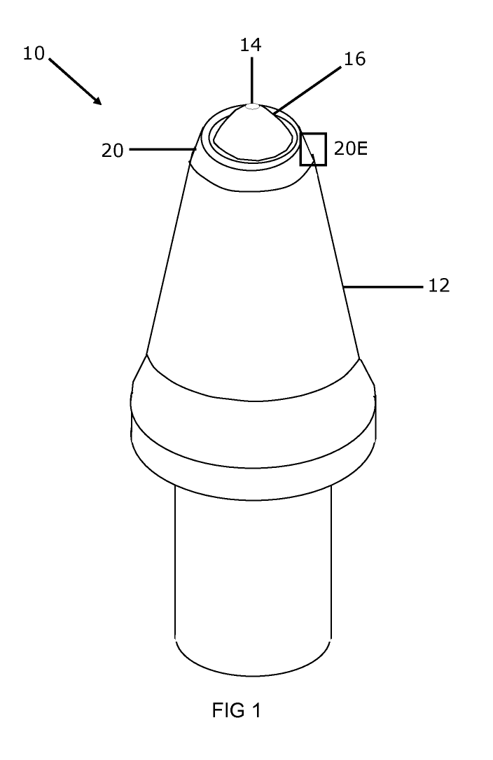

With reference to FIG. 1, an example body 10 for a pick tool, comprising a steel substrate 12 and a hard face structure 20 fused to the steel substrate 12. The pick tool 10 further comprises a tip 14 of polycrystalline diamond joined to a cemented tungsten carbide base 16.

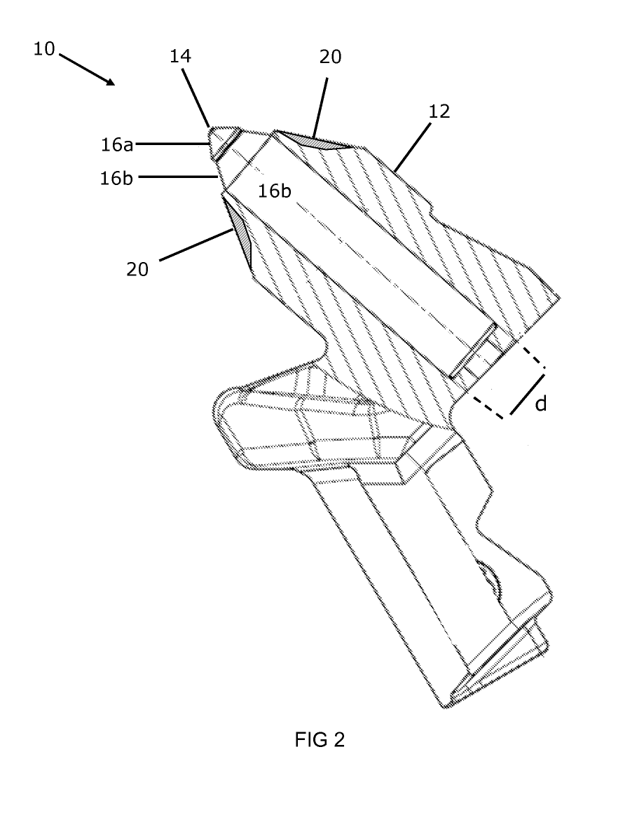

With reference to FIG. 2, an example body 10 for a pick tool, comprising a steel substrate 12 and a hard face structure 20 fused to the steel substrate 12. The pick tool 10 further comprises a tip 14 of polycrystalline diamond joined to a cemented tungsten carbide base 16.

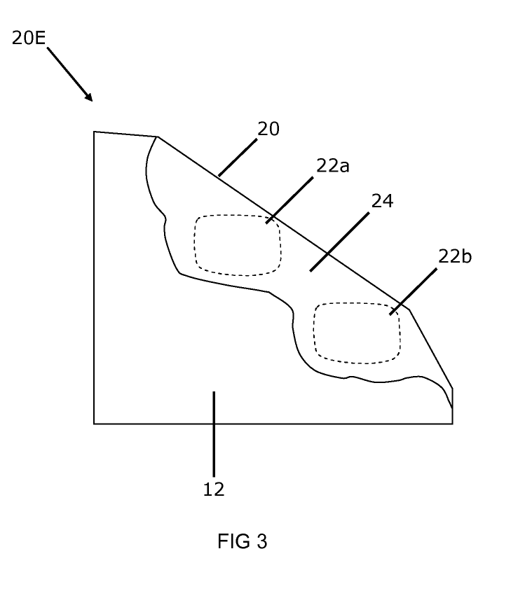

With reference to FIG. 3, an example hard face structure 20 comprises two substantially co-axial core regions 22a and 22b and an intermediate region 24, the intermediate region 24 at enclosing both core regions 22a and 22b.

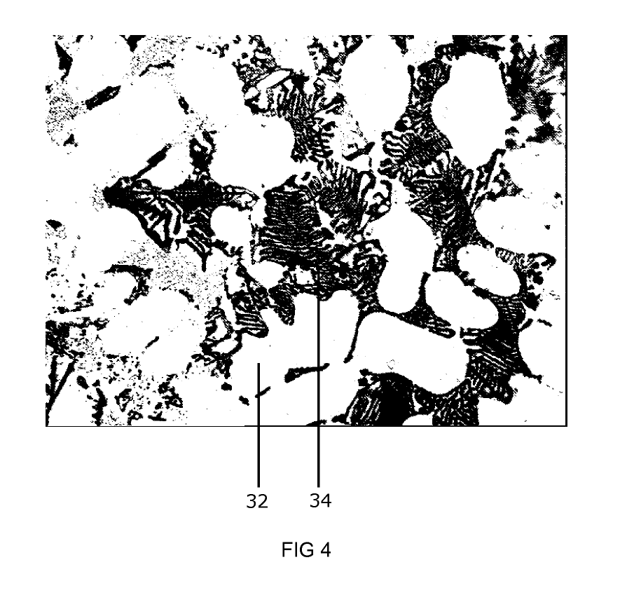

With reference to FIG. 4, an example intermediate region includes a plurality of dendritic crystallites 34 comprising at least one eta-phase or theta-phase according to the formula MₓW_{y}C_{z}, where x is in the range from 1 to 7, y is in the range from 1 to 10 and z is in the range from 1 to 4, or a mixture of an eta-phase and a theta-phase according to the formula. The intermediate region includes a phase 32 that is rich in an iron group metal M, selected from Fe, Co and Ni or an alloy thereof. The intermediate region comprises a mean Si content of at least about 0.5 weight %, a mean Cr content of at least about 3 weight % and a mean W content of at least about 10 weight % and substantially the balance of the intermediate region consisting of the metal M. The intermediate region includes a phase that is substantially free of WC grains.

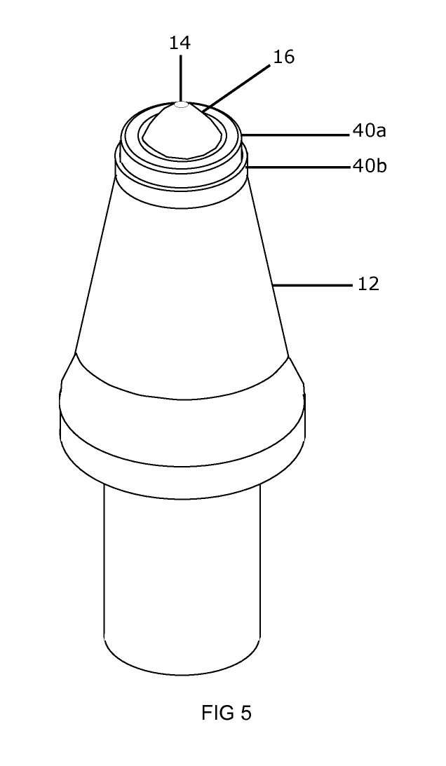

With reference to FIG. 5, an example hard face structure may be made by a method including fusing two green body precursor rings 40a and 40b to a generally conical steel portion 12 of a pick tool for pavement degradation. In one version, the precursor rings may comprise a precursor material for a hardmetal as described in WO/2010/029518 and WO/2010/029522. The pick tool further comprises a tip 14 of polycrystalline diamond joined to a cemented tungsten carbide base 16. The precursor rings 40a and 40b have different diameters for fitting around the conical steel portion 12 at adjacent longitudinal positions. The precursor rings are unsintered green bodies comprising at least 13 volume % WC grains, Si in the range from about 0.1 weight % to about 10 weight %, and Cr in the range from about 0.1 weight % to about 10 weight %. The liquidus temperature of the green body precursor rings is at most about 1,280 degrees centigrade. The two precursor rings 42a and 42b are placed snugly around the conical steel portion 12 and against each other, and then heated to at least about 1,300 degrees centigrade, causing them to melt and to react and fuse with the steel of the adjacent portion 12 of the steel tool body. The heating is applied for a period of time sufficient to allow a peripheral region of the precursor rings to react and fuse with the steel and to avoid complete reaction of core regions of the precursor body with the steel.

In one version of the method, the precursor body contains diamond or CBN particles.

In one version of the method, the method includes configuring the shape of the hard face precursor body to fit against the shape of a non-planar surface of the steel substrate. In one embodiment of the invention, the non-planar surface of the steel substrate is arcuate. In one embodiment of the invention, the non-planar surface includes an edge or sharp bend.

In one version of the method, the temperature is at least about 1,200 degrees centigrade and at most about 1,300 degrees centigrade and the time period is at least about 1 minute and at most about 5 minutes.

In one version of the method, the method includes configuring the substrate to comprise a generally cylindrical, conical or frustoconical side portion, and the hard face precursor body has the general shape of annulus or ring configured in size and shape to be capable of fitting around the side portion.

The disclosed method may have the aspect of resulting in a very effective hard face structure intimately welded onto the body.

A non-limiting example is described in more detail below.

Two green body precursor rings were prepared as follows. A 1 kg batch of powders comprising 67 weight % WC powder with a mean diameter of about 0.8 microns, 24 weight % Co powder, 6.4 weight % Cr₃C₂ powder and 1.6 weight % Si powder was milled for six hours in an attritor mill in a medium of hexane and 20 g paraffin wax and 6 kg hard-metal balls. After milling, the resulting slurry was dried and the powder was screened to eliminate agglomerates. Hardmetal rings were pressed and pre-sintered at 800 degrees centigrade for 1 hour in vacuum.

The two green body rings were mounted onto the steel body of a pick for pavement degradation, and the assembly was heat-treated in a nitrogen rich atmosphere at a temperature of 1,250 degrees centigrade for about 4 minutes in an argon atmosphere by use of conventional equipment used for brazing. The HV10 hardness of the coating was found to be roughly 850 Vickers units.

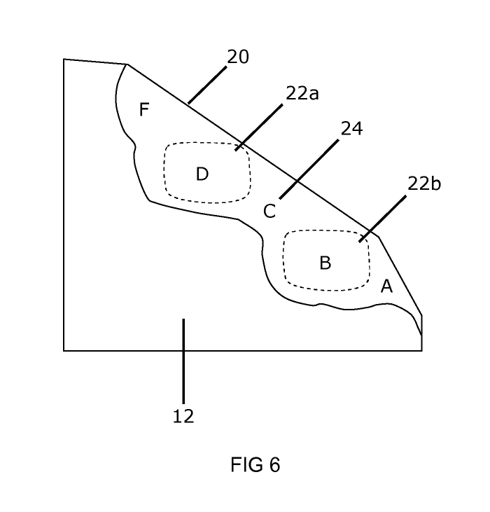

With reference to FIG. 6, which shows a schematic drawing of a partial cross section of the hard face structure 20 fused to the steel body 12 of the pick (not shown in full) after the heat treatment, the near-surface hard face structure 20 comprised two core regions 22a and 22b, each corresponding to a respective precursor hardmetal ring (not shown), embedded within and completely enclosed by an intermediate region 24. The HV10 Vickers hardness and elemental composition of the hard face structure was measured at each of five locations indicated by A, B, C, D and E. The results are shown in table 1 below.

TABLE 1

| Property | A | B | C | D | E |
|---|---|---|---|---|---|
| HV10 | 830 | 740 | 800 | 780 | 820 |
| W, wt. % | 15.1 | 58.8 | 18.8 | 63.8 | 21.2 |
| Si, wt. % | 0.8 | 2.5 | 1.1 | 2.2 | 1.4 |
| Cr, wt. % | 4.4 | 3.5 | 5.7 | 9.1 | 5.3 |
| Fe, wt. % | 79.9 | 30.2 | 74.3 | 25.0 | 72.1 |

The microstructure of the core regions comprised grains of WC and (Fe,Cr),C₃ embedded in Fe-based binder material. The microstructure of the intermediate region comprised dendritic crystallites of Fe₃W₃C eta-phase embedded in Fe-based binder material. With reference to FIG. 3, the composition of the dendritic crystallites 34 and the Fe-rich phase 32 are shown in table 2 below (since the carbon content was not measured, only the metal contents are shown). The fracture toughness of the core region was about 24.2 MPa.m^{1/2} and that of the intermediate region was about 26.0 MPa.m^{1/2}.

TABLE 2

| | | Fe-rich |
|---|---|---|
| | Eta-phase 34 | phase 32 |
| Element | Wt. % | Wt. % |
| Si | 2.6 | 1.7 |
| Cr | 2.3 | 3.6 |
| Fe | 34.0 | 73.3 |
| W | 25.7 | 10.7 |

1. A body comprising a steel substrate and a hard face structure fused to the steel substrate, the hard face structure comprising a core region and an intermediate region, the intermediate region at least partially enclosing the core region and comprising at least 0.5 weight % Si, at least 3 weight % Cr and at least 10 weight % W and substantially the balance of the intermediate region consisting of an iron group metal M and carbon. M being selected from Fe, Co and Ni or an alloy thereof, and the intermediate region including a plurality of crystallites comprising at least one eta-phase or theta-phase according to the formula MₓW_{y}C_{z}, where x is in the range from 1 to 7, y is in the range from 1 to 10 and z is in the range from 1 to 4, or a mixture of an eta-phase and a theta-phase according to the formula; the core region comprising at least 1 weight % Si, at least 5 weight % Cr, at least 40 weight % W and substantially the balance of the core region consisting of M and carbon, the core region including grains comprising WC and grains comprising (M,Cr)₇C₃ or grains comprising (M,Cr)₂₃C₆, or grains comprising (M,Cr)₇C₃ and grains comprising (M,Cr)₂₃C₆, the grains being dispersed in core region matrix material comprising more than 50 weight % of the M containing Cr, W and Si in solid solution therein; the intermediate region being substantially free of WC grains.

2. A body as claimed in claim 1, in which the grains of the eta-phase or the theta-phase, or both, comprise at least 1 weight % Cr and at least 1 weight % Si, the eta-phase phase or theta phase, or both, being dispersed in an intermediate region matrix material comprising at least 1 weight % Si and at least 2 weight % Cr.

3. A body as claimed in claim 1, in which the grains comprising (M,Cr)₇C₃ or the grains comprising (M,Cr)₂₃C₆, or both, comprise at least 1 weight % Si and the core matrix material comprises at least 1 weight % Si, at least 5 weight % W and at least 5 weight % Cr.

4. A body as claimed in claim 1, in which the intermediate region has a thickness of at least 0.5 mm, the thickness being the shortest distance between a point lying on the boundary with the core region and the closest point lying on the boundary with the steel substrate.

5. A body as claimed in claim 1, in which the core region and the intermediate region of the hard face structure have Vickers hardness of at least 700 HV10.

6. A body as claimed in claim 1, in which the core region and the intermediate region of the hard face structure have Vickers hardness of at least 800 HV10.

7. A body as claimed in claim 1, in which the core region and the intermediate region of the hard face structure have a Palmquist fracture toughness of at least about 20 MPa.m^{1/2}.

8. A body as claimed in claim 1, in which the hard face structure comprises a plurality of core regions embedded within the intermediate region.

9. A body as claimed in claim 1, in which the body is a tool or a wear part for use in pavement or rock degradation.

10. A body as claimed in claim 1, comprising a tip formed of polycrystalline diamond.

11. A body as claimed in claim 1, in which the body is a pick tool for pavement degradation, comprising a steel substrate having a longitudinal axis and having a generally cylindrical, conical or frustoconical portion and a generally annular or other co-axial hard face structure fused to the steel substrate.

12. A method for making a body as claimed in claim 1, the method including contacting a precursor body with a steel substrate, the precursor body comprising at least 13 volume % WC grains. Si in the range from 0.1 weight % to 10 weight %, and Cr in the range from 0.1 weight % to 10 weight %, the rest is M, and having a liquidus temperature of at most 1,280 degrees centigrade; heating the precursor body to a temperature of at least the liquidus temperature for a time period controlled to allow a peripheral region of the precursor body to react and fuse with the steel and to avoid complete reaction of a core region of the precursor body with the steel.

13. A method as claimed in claim 12, in which the precursor body contains diamond or CBN particles.

14. A method as claimed in claim 12, the method including configuring the shape of the hard face precursor body to fit against the shape of a non-planar surface of the steel substrate.

15. A method as claimed in claim 13, in which the temperature is at least 1,200 degrees centigrade and at most 1,300 degrees centigrade and the time period is at least about 1 minute and at most 5 minutes.

16. A body as claimed in claim 2, in which the grains comprising (M,Cr)₇C₃ or the grains comprising (M,Cr)₂₃C₆, or both, comprise at least 1 weight % Si and the core matrix material comprises at least 1 weight % Si, at least 5 weight % W and at least 5 weight % Cr.

17. A method as claimed in claim 13, the method including configuring the shape of the hard face precursor body to fit against the shape of a non-planar surface of the steel substrate.
